(19) United States
(12) Patent Application Publication
(10) Pub. No.: US 2015/0379759 A1
(43) Pub. Date: Dec. 31, 2015

(54) SYSTEM AND METHOD FOR RENDERING BUILDINGS IN THREE DIMENSIONS

(71) Applicant: Jagonal Pty Ltd, Sydney (AU)

(72) Inventor: Sergiy KOTLYAROV, Sydney (AU)

(21) Appl. No.: 14/754,712

(22) Filed: Jun. 30, 2015

(30) Foreign Application Priority Data
Jun. 30, 2014 (AU) 2014902512

(51) Int. Cl. G06T 15/08; G06T 15/40

(52) U.S. Cl. CPC G06T 15/08; G06T 15/40

(57) ABSTRACT

To quickly render buildings in a three dimensional building landscape on graphical use interface, buildings may be described with sufficient accuracy by dividing the building into a number of building objects having a base polygon that is projected upwards for a specified height. The building objects may have a consistent horizontal cross section or may be projected to a roof polygon having an equivalent number of boundary data points. The building files may be coupled with property listing data so that available floor space in a building is depicted on the 3-D building landscape.

### CROSS REFERENCE TO RELATED APPLICATIONS

This application claims priority to Australian provisional patent application AU 2014902512, filed 30 Jun. 2014, the contents of which are herein incorporated by reference.

### FIELD OF THE INVENTION

This disclosure relates to systems and methods for graphically depicting objects in three dimensions. The disclosure applies particularly, though not exclusively, to buildings.

### BACKGROUND OF THE INVENTION

There are various mapping software applications available today. One application is Google Maps. Google Maps and other such applications typically depict a two dimensional plan or overhead view of a geographic area. Location information, such as street names, buildings, points of interest can be indicated by icons on the map layout. The icons may be hyperlinks to more information about a particular site or location.

These mapping applications are growing in sophistication and are starting to represent areas in three dimensions with graphical depictions of objects rather than representing the objects by simple icons.

A problem with representing maps in three dimensions is that they are data intensive. For example, Google™ offers a software package called SketchUp™ that enables any user to construct a three dimensional representation of a buildings that can then be incorporated into the 3-D mapping software. The SketchUp package aims to create accurate depictions of buildings leading to the most accurate representation of a city landscape.

A problem with aiming for accuracy is that the amount of data, e.g. number of data values, required to represent a single building makes the building data file quite large. When a large number of buildings have to be displayed simultaneously, e.g. when displaying a city landscape, the entire data set becomes unwieldy, making it difficult to deliver a city landscape in real-time, i.e. at a speed that allows a user to quickly pan the cityscape. A further problem is that because the amount of data required just to display the buildings is large, this reduces the amount of additional and potentially more useful information that can be displayed in conjunction with the cityscape. There may be substantial quantities of additional information that could be served in real-time that is more functional than an accurate and detailed depiction of a building.

What is required is an improved system and method for representing objects on a map.

### SUMMARY OF THE INVENTION

In one aspect, there is provided a method for defining a three dimensional model of a building. The method may include dividing a building into a plurality of objects, one or more of the objects having a substantially consistent horizontal cross section through a height of the respective object, and defining each object as a series of data points. Defining an object may include determining the coordinates that define a boundary of an object's cross section and determining one or more data points that describe the height of the object. The method may include storing a definition of each object in a building data file.

In one aspect, there is provided a computer system programmed to support the above method.

In one aspect, there is provided a method of creating a building data file including presenting, by a computer system including at least one processor and at least one operatively associated memory, an interface on a display associated with the computer system that enables a user to define, through the interface, a plurality of building objects that describe a building. The interface may present a mapping interface that enables a user to draw or otherwise enter a boundary of a cross section of a building object on a map and to enter one or more height parameters of the building object. The interface may be programmed to store each of the building object definitions for the building in the building data file.

In other aspects, there is provided a computer application and computer system for performing the above method.

In one aspect, there is provided a method for presenting a three dimensional building landscape on a graphical user interface. The method may include determining an x,y coordinate space of a viewport or mapping screen of the graphical user interface, searching a database of building data files to determine one or more building data files that have x,y coordinates within the x,y coordinate space and rendering the determined building data files as three dimensional images on the graphical user interface, wherein the building data files include one or more buildings described by a plurality of building objects, the building objects including a horizontal cross section defined by a series of x,y data points and a height of the respective building object.

In one aspect, there is provided a system for presenting a three dimensional building landscape on a graphical user interface. The system may include at least one database of building data files including at least one building described by a plurality of building objects, the building objects including a horizontal cross section defined by a series of x,y data points and a height of the respective building object. The system may include at least one processor operatively associated with the at least one database, the at least one processor programmed to determine that the at least one building is to be displayed on the three dimensional building landscape, create a building object by projecting the horizontal cross section of at least one of the plurality of building objects from a base height of the respective building object to a roof height of the respective building object, and display the created building object as a three dimensional image on three dimensional building landscape of the graphical user interface.

In other aspects, there is provided a computer application and computer system for performing the above method.

### BRIEF DESCRIPTION OF THE DRAWINGS

Reference will now be made, by way of example only, to specific embodiments and to the accompanying drawings in which:

FIG. 1 depicts a computer system that can be used to implement one or more embodiments of the present invention;

FIG. 2 depicts a prior art method for defining a rectangular box object;

FIG. 3 depicts a method for defining a rectangular box object in accordance with an embodiment of the present invention;

FIG. 4 depicts a method for defining a cylindrical object in accordance with an embodiment of the present invention;

FIG. 5 depicts a method for defining an irregular polygon object in accordance with an embodiment of the present invention;

FIG. 6 depicts a user interface of a building data file creation application;

FIG. 7 depicts a client/server system for displaying a building landscape;

FIG. 8 depicts a building object having an additional roof polygon different to the floor polygon;

FIG. 9 depicts a boundary of a property listing polygon relative to a building object polygon; and

FIG. 10 depicts a rendering of property listing polygon of FIG. 9.

### DETAILED DESCRIPTION OF THE INVENTION

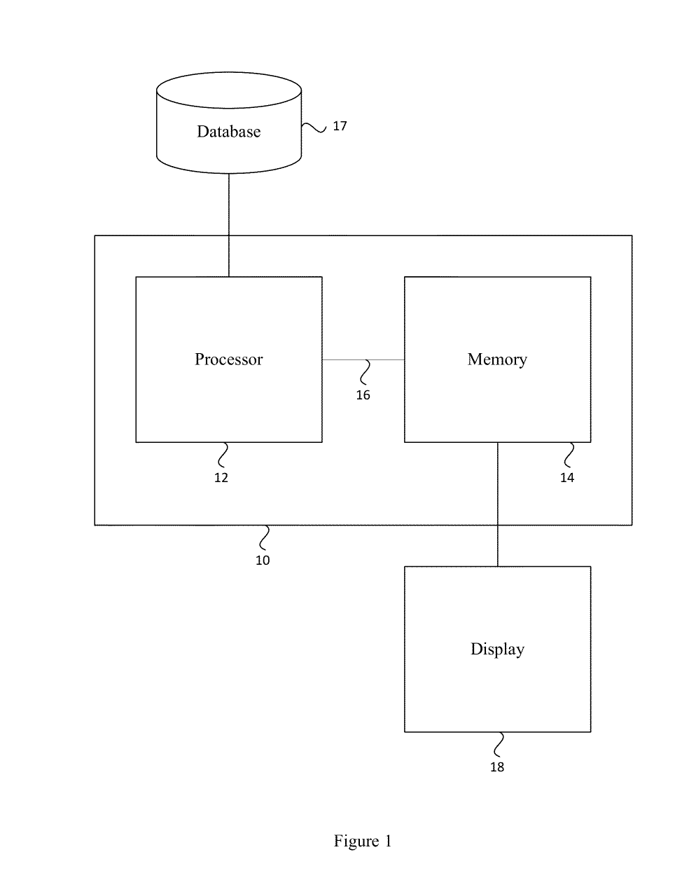

Methods in accordance with various embodiments of the present disclosure may be implemented on a computer system depicted generally in FIG. 1. The computer system 10 may include a processing unit 12 which may include one or more processors, which may be distributed or co-located. Processing unit 12 may be operatively associated with system memory 14, e.g. via a system bus 16. The system bus 16 may be any of several types of bus architectures including a memory bus, a memory controller, a peripheral bus, etc. The system memory 14 may include random access memory (RAM) and/or read only memory (ROM). The computer system 10 may further include one or more databases depicted singularly at 17 in FIG. 1. The database(s) may be singular or multiple and may be distributed as required. The particular configuration of the computer system 10, its components and architecture are not considered pertinent to the present disclosure and many forms of the computer system will be apparent to the person skilled in the art, with all such forms intended to be encompassed herein.

For example, the computer system 10 may be a single integrated device, such as a desktop computer, laptop, mobile device, etc. Alternatively, the computer system 10 may be a distributed system including multiple computers, i.e. multiple processors and memories and may include server and client devices. Components of the computer system 10 may communicate with each other and with other computer systems through any suitable means, including direct hardwired connections and/or through various wired or wireless communication networks such as internet, mobile networks, local area networks, etc. using any suitable known protocol, e.g. TCP/IP.

The computer system 10 may be operatively associated with one or more displays, shown singularly at 18 in FIG. 1, which may be any type of display suitable for displaying information to a user.

The system memory 14 may store application code that can be accessed and executed by the processing unit 12. Various embodiments of application code will be described hereinbelow.

The processing steps described herein, while described discretely, may be steps performed entirely within the memory of the computer system 10. The results of the individual steps described herein may be files or data that are stored for a time or may be data that only exists within the processing memory, such as within buffers or registers, until subsequent steps are performed. That is, the processing steps described herein may or may not have discrete outputs.

The present inventors have realised that in some instances and for some purposes, it can be better to sacrifice accuracy of a buildings depiction in a building landscape (cityscape) in order to increase server speed and to enhance auxiliary data services relating to the presentation and depiction of a building landscape.

The present inventors have thus devised a model for representing a building within a building landscape that provides sufficient depiction of the building to enable the auxiliary data to be conveyed. The model was developed to display property listings on a 3-dimensional city, industrial or suburban landscape though other uses of the model will be apparent to the person skilled in the art.

In one embodiment, a building is broken down into a number of objects that have a consistent cross section, in particular, though not exclusively, a consistent horizontal cross section. Each object of the building can therefore be described by the series of x,y coordinates that define the boundary or shape of the base cross section of the object together with data that describes the height of the object. Typically, the height can be described by two data values, e.g. the height of the base of the object and the height of the top of the object. Alternatively, the height can be described by a starting height and a height value. The height value may be given in metres or in the number of floors.

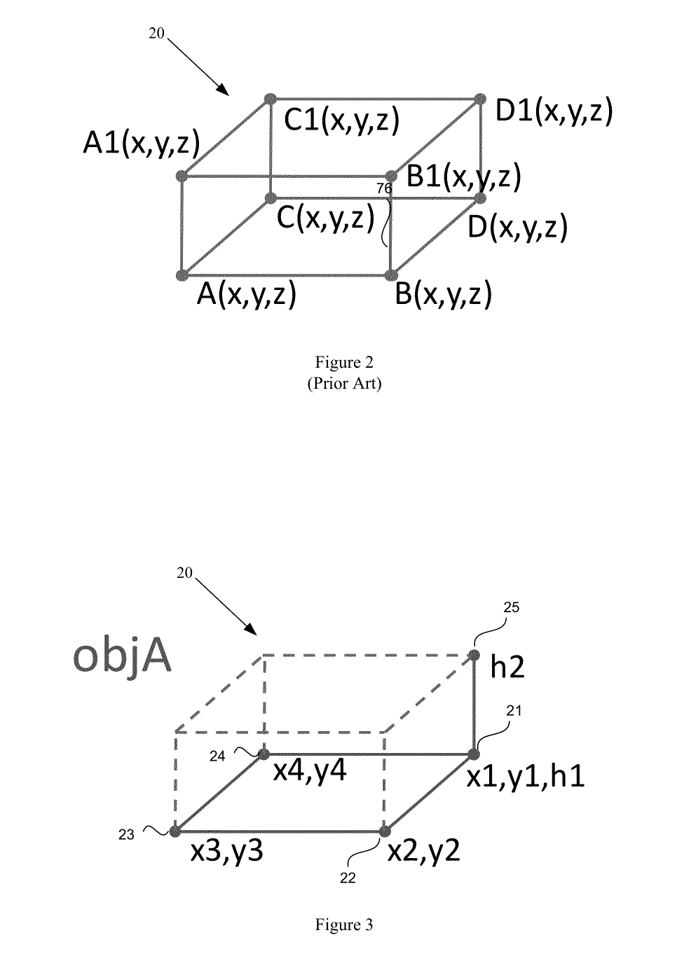

By way of example, FIG. 2 shows a first object 20 as a rectangular box. A prior art method, known as X3D, would describe the rectangular box as a series of faces. The X3D description would be as follows:

{ faces: [

[A,B,D,C],[A,A1,B1,B],[B,B1,D1,D],
[D,D1,C1,C],[C,C1,A1,A], [A1,B1,D1,C1]

],
points: [

[x,y,z],[x,y,z],[x,y,z],[x,y,z],
[x,y,z],[x,y,z],[x,y,z],[x,y,z]

] }

That is, the prior art description requires six faces to be characterised that are made up of the eight vertices.

FIG. 3 shows the same rectangular box 20 described using the Applicant's methodology. The object 20, ObjA, is described by the x,y coordinates of the four corners 21, 22, 23, 24 of the base rectangle. The object is further described by two height parameters, h1 and h2 25. ObjA may thus be represented in the Applicant's methodology as follows:

{

“name”:“objA”,
“colour”:“#0070C0”,
“poly”:[

[x1,y1],
[x2,y2],
[x3,y3],
[x4,y4]

],
“z”:[h1,h2]

},

The object ObjA 20 description above describes a name: ObjA, colour and shape type polygon indicated by the term “poly”. Other parameters that may be described include a rendering texture, transparency, ability to emit, absorb and reflect light, specific behavior on user action (e.g., changing any of above on click or mouse over an object) or on environment changes (e.g., glow at night). The shape itself requires only the four base vertices and two height parameters, leading to an decreased data size compared to the prior art X3D model. Instead of characterizing the faces individually, rendering software associated with the Applicant's methodology is able to take two consecutive x,y data points of the base cross section and, using the shape type parameter, project the line between the two points to the height of the object to thereby construct the face. By repeating the process for each line of the base cross section, each surface of the building object may be projected to the object's height, leading to a three dimensional rendering of the building object.

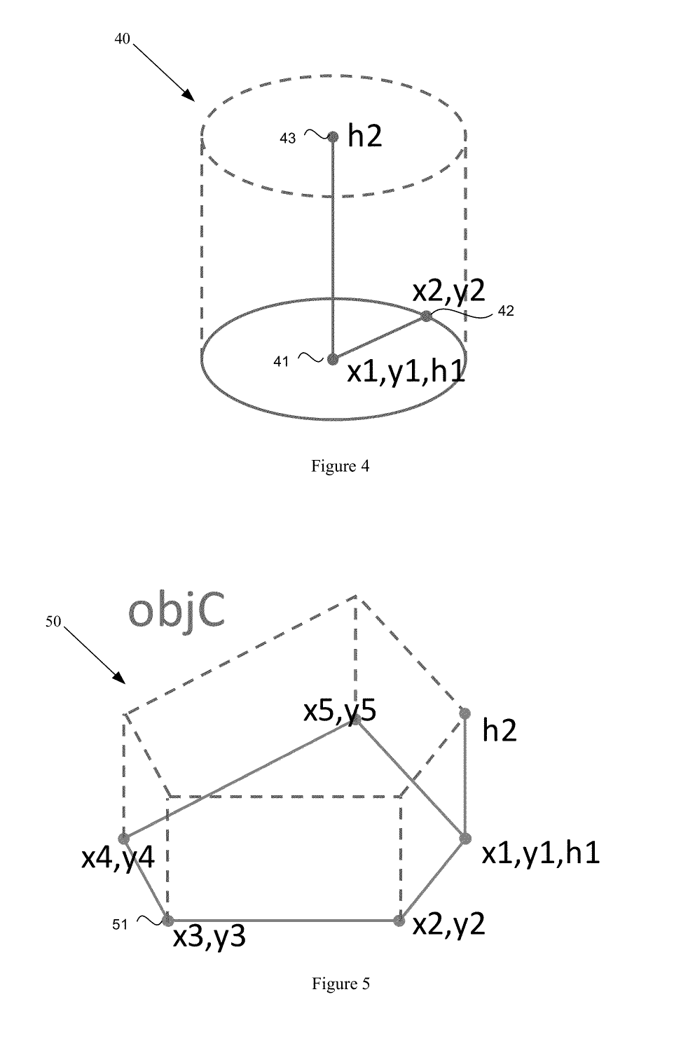

FIG. 4 shows how the method of an embodiment of the present invention would describe a cylindrical object, ObjB. The cylinder 40 is described by a centre point 41, (x1,y1), either a radius of the base circle or an additional point 42 on the circumference, and height parameters 43. The ObjB description would therefore be represented as follows:

{

“name”:“objB”,
“colour”:“#FF0000”,
“circle”:[

[x1,y1],
[x2,y2]

],
“z”:[h1,h2]

}

In this description, the object is given a “circle” shape type. This characterization enables the rendering software to construct the circle from the two given x,y coordinates and to then project the surface of the cylinder. The first given x,y coordinate will be the centre and the following coordinate will be a coordinate on the circumference. The software application can deduce the radius of the circle from the two x,y coordinates and complete the construction of the circle from the calculated radius.

FIG. 5 shows how the method of an embodiment of the present invention would describe an irregular polygon object 50, ObjC. ObjC is depicted as a five sided object and therefore has five vertices on the base, e.g. vertex 51, with each vertex being represented by an x,y coordinate. The height of ObjC can be represented by two height parameters that represent a height of the base level and a height of the top level of the object. The description for ObjC may therefore be represented as follows:

{

“name”:“objC”,
“colour”:“#00FF00”,
“poly”:[

[x1,y1],
[x2,y2],
[x3,y3],
[x4,y4],
[x5,y5]

],
“z”:[h1,h2]

}

This description only requires five base points and two height points to represent the object. The same object described in the prior art X3D model would require a description of seven faces made up of the ten vertices, with each vertex requiring x,y,z coordinate (i.e. three data values) compared to the two data values required to represent the coordinates of each vertex of the base cross section in the Applicant's model.

From the above, it will be apparent that the Applicant's model can reduce the amount of data required to describe a building.

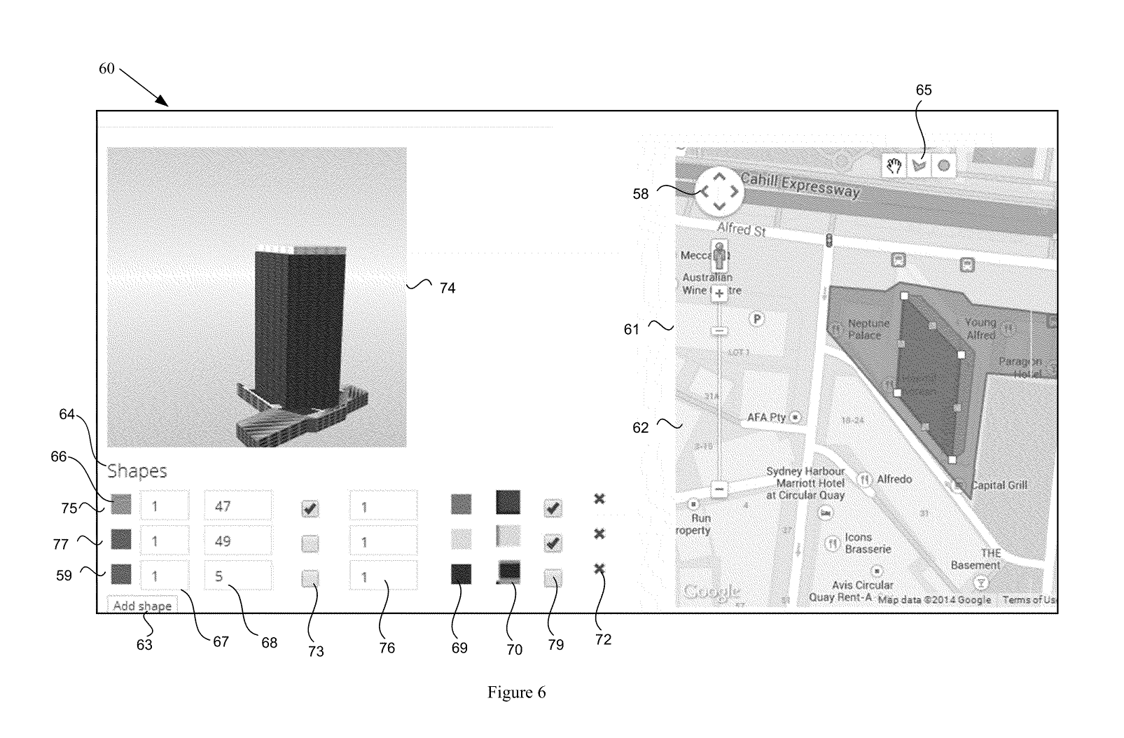

FIG. 6 shows an embodiment of an application, executable by a computer device, that presents an interface through which a building data file may be created. The interface 60 includes a mapping window 61 that displays a map 62. The map 62 may be derived from third party software, such as Google Maps™ or any other appropriate mapping software. The mapping window is controllable through known pan, zoom and search functions 58 in order to locate an address of interest for display on the mapping screen 61.

Once a location or address has been selected on the mapping screen 61, the user is able to commence construction of a building data file. The user may first select to add a building object to a building data file by selecting an “Add Shape” icon 63. This creates a building object in the building data file and displays a building object in the shape list 64. Each building object in the shape list 64 is represented by a row, e.g. row 59, which displays the parameters of the respective building object. The user may draw an outline of the first building object on the mapping window 61. For example, the user may select a shape type, e.g. “polygon” or “circle” from a shape type menu 65 and then click corners of the building object cross section on the mapping screen 61 to define the boundary of the polygon cross section. X,y coordinates of the building object may be determined by correlating the mouse click positions with the mapping interface. Alternatively, the user may enter data points as specific x,y coordinates (e.g. in absolute or relative latitude/longitude) to define the boundary of the polygon cross section. It can be seen in the shape list that each building object is assigned a colour 66. This colour is used to depict the respective building object on the map 61 so that the different building objects that make up a building can be readily identified and selected.

In addition to defining the boundary of a building object, the user is able to enter height parameters of the building object. In the embodiment depicted, the user is able to enter a base height 67 and a top height 68. For the embodiment depicted, the height unit is the number of floors. That is, the building object defined in row 59 of the shape list 64 extends from floor 1 to floor 5. In alternative embodiments, the height parameters may be specified as a starting floor height followed by a number of floors for the building object. The system may store a default floor height or a floor height may be specified within the building data file. In a further alternative, height parameters may be specified in distances, e.g. metres.

The interface 60 also allows a user to specify a colour 69 and texture 70 of the building object. A set of available colours and textures may be stored within the application. Additional colours and textures may be created and uploaded to the application. Additional shape parameters may be specified. A first checkbox 73 may be used to represent whether a surface of the object will reflect other objects (like glass or metal). A second checkbox 79 may indicate that the shape is “important” and will be shown from the distance, i.e. depending on zoom scale or distance of the map. Unchecked shapes are insignificant and will be hidden when building is far away. An additional parameter 76 may be used to represent how a texture or shape is stretched. For example, a “1” in parameter box 76 may indicate that the texture is a square, “0.5” may mean it is landscape oriented with dimensions 2:1 and “2” may mean it is portrait oriented with dimensions 1:2.

Building objects may be deleted from the shape list by selecting the remove icon 72.

Additional building objects may be added to the building data file, starting with selection of the “Add Shape” icon 63 as described above.

The creation application includes a preview window 74 that displays a three dimensional image of the building based on the defined building objects in the shape list 64, including the applied textures and colours. Through this preview window 74, the user is able to view how the building will appear when rendered. It should be noted that the shape colour 66 is only used on the mapping window 61 to distinguish the building object from other building objects on the map. The colour that is applied to the final 3-D building image and preview is derived from the specified building object colour in field 69.

In the example depicted, the building includes three distinct building objects. The first object of row 59 represents the 10-sided irregular polygon that forms the lower 5 floors of the building. A second object, shown in row 77, is a 6-sided polygon that extends up to the 47^{th} floor of the building and a third building object, shown in row 77 is a 4-sided polygon that represents the roof structure forming the top two floors of the building. It is noted that each object is indicated as extending from the first floor. The rendering software is programmed to display the building surfaces as opaque in the 3-D image. Thus, while it can be seen on the map view 61 that the three building objects overlap, the 3-D image in the preview window 74 shows only the visible outer surfaces of the building so that, for example, the bottom five floors of the second and third building objects are hidden by the opaque surfaces of the first building object. This method is suitable where successively higher building objects fully nest within the lower building objects. In an alternative, the second object could be indicated as extending from floor 5 to floor 47 and the third object could be indicated as extending from floor 47 to floor 49 so that there is no overlap of the building objects. This alternative can be used where successively higher objects do not fully nest within lower objects such that a higher building contains portions that extend out and above the lower building objects. Tower structures of which Sydney Centrepoint Tower is one example have such structures.

The building data file that defines the building depicted in FIG. 6 will include 3 building object definitions as follows:

{“name”:“building name”,
“floor height”:“3.6m”,

[

{“name”:“10-sided base”,
“colour”:“A0FFFF”,
“polygon”:[

[x1,y1],
[x2,y2],
[x3,y3],
[x4,y4],
[x5,y5],
[x6,y6],
[x7,y7],
[x8,y8],
[x9,y9],
[x10,y10],

],
“z”:[h1,h2]

},
{

“name”:“6-sided tower”,
“colour”:“FFA0FF”,
“polygon”:[

[x11,y11],
[x12,y12],
[x13,y13],
[x14,y14],
[x15,y15],
[x16,y16],

],
“z”:[h1,h3]

},
{

“name”:“4-sided roof”,
“colour”:“FFFFA0”,
“polygon”:[

[x11,y11],
[x12,y12],
[x13,y13],
[x17,y17],

],
“z”:[h1,h4]

}
]

}

The building data file may be stored in a building file database, such as database 17 shown in FIG. 1. As stated previously, the x,y coordinates may be given in absolute latitude/longitude values, relative grid values or some other appropriate parameter as will be apparent to the person skilled in the art. The height parameters (z values) may be expressed as absolute values such as metres above sea level, or in relative values such as metres above floor height. The z values may also be expressed as floor values, e.g. number of floors above ground floor. The building file header, may include various details include a building name, address, floor height, links to building data, total number of floors, etc. Other data that may be included in the building data file may be dependent on the specific application and will be apparent to the person skilled in the art. While each shape only shows colour data, additional data in each shape may be specified, including texture, reflectiveness and parameters that specify how the shape is viewed in zoom, from afar, stretched, etc.

The building data file required to define the building depicted in FIG. 6 using the Applicant's methodology is approximately 3.6 kB. By contrast, the same building defined by a prior art method requires approx 186 kB. When replicated across many buildings of a city landscape, these data savings can be significant when it comes to serving a representation of city landscape in real time, in particular where additional data associated with the buildings is to be provided.

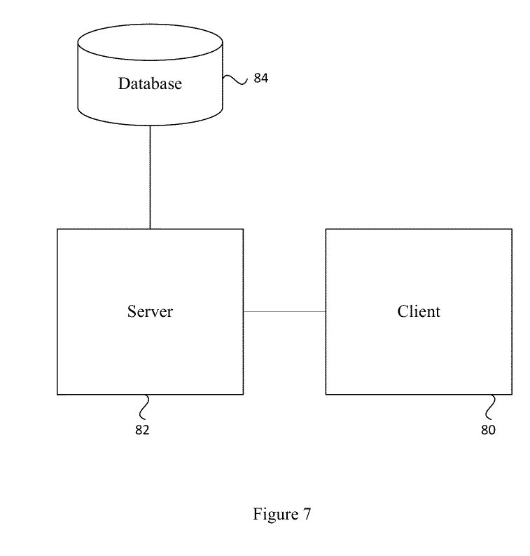

FIG. 7 shows a client/server system that may be used to display a 3-D building landscape. The client 80 and server 82 may be configured to communicate through any suitable protocol such as via a local area network, wide area network (internet), mobile communications network, etc. The client 80 may operate a browser or similar user interface that runs a mapping application. The mapping application originates a request at the client for mapping data, including building data, to be displayed on the client browser. The initial mapping data may be determined by a location search or by a default view created in the client browser. The client request is sent to the server 82 and may include viewport information that describes an x,y coordinate space visible in the browser.

A server application executing on the server 82 receives the client request including the x,y coordinate space information. The server conducts a search on the database 84 that stores building data files to determine the buildings within the x,y coordinate space.

At least one of the server application or the client application may include rendering software that is programmed to extract the data from each of the building data files returned by the search and create a three dimensional rendition of the respective building for display on the client browser at the relevant map location. For example, the rendering software may be programmed to take two consecutive x,y data points of a base cross section of a building object (e.g. (x1,y1) and (x2,y2)), project the line between the two points to the height of the object to create a surface (e.g. (x1,y1,h1); (x2,y2, h1); (x2,y2,h2) and x1,y1,h2), and apply the specified colours and textures specified in the building data file to the surface, repeating the process for each set of consecutive data points around the base polygon until the base polygon is fully projected and then replicating the entire process for each building object of a building data file. Other rendering and projection methods will be apparent to the person skilled in the art. Applications and software for rendering 3-D images are well known in the art and the present embodiments may use any of the standard and commercially available packages. Further description of the rendering process is not considered essential to the present invention.

The client mapping application may include standard mapping navigation tools such as pan and zoom that enable the user to change the x,y coordinate space in the browser viewport. As the x,y coordinate space is changed, new requests reflecting the mapping navigation may be sent from the client to the server as is known. The server may respond to the new requests by retrieving any building data files that are to be displayed from the database 84.

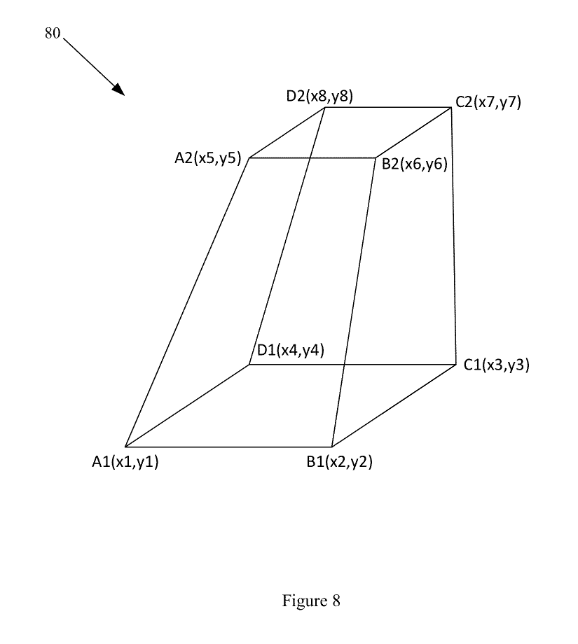

The embodiments described above are well adapted to handle buildings of complex geometries by breaking down the building into objects having consistent cross-sections. In order to handle still more complex geometries, a further parameter can be added to a building object. The additional parameter can be a boundary definition of a ceiling shape. With reference to FIG. 8, a building object 90 “objD” has a four point base (A1, B1, C1, D1) and a four point roof (A2, B2, C2, D2) that is not identical to the floor object. The building object may be parameterized by the addition of a roof polygon.

ObjD may thus be represented in the Applicant's methodology as follows:

{

“name”:“objD”,
“colour”:“#0070C0”,
“poly”:[

[x1,y1],
[x2,y2],
[x3,y3],
[x4,y4]

],
“poly”:[

[x5,y5],
[x6,y6],
[x7,y7],
[x8,y8]

],
“z”:[h1,h2]

},

To create a 3-D image from the building file, the surfaces of the building object objD may be created by joining the first data point of the floor polygon A1 (x1,y1) to the first data point of the roof polygon A2 (x5,y5). That is, there is a one-to-one mapping of the data points from the floor polygon to the ceiling polygon and the order in which the data points is defined is important. By programmatically setting the one-to-one mapping of the data points, and the manner in which the building image is constructed, it is not necessary to define the surfaces using any more data points than are discussed above.

It is also not necessary to specify by additional data that the building object is a complex shape. The rendering software can be programmed to detect the presence of the roof polygon in the building object definition. If no roof polygon is detected, the rendering software can revert to the default position which is to extend or project the base polygon to the specified height.

While a multi-sided polygon is depicted in FIG. 8, other shapes can be represented. For example, a floor circle can map to a roof circle to produce a conical shape by providing a one to one correlation between points on the circumference of the base circle and points on the circumference of the roof circle.

In one embodiment, a building object may include additional rendering parameters such as a slope or tilt vector. Such a vector may define that a base polygon is projected upwards but then tilted, rotated or otherwise modified according to the vector.

The building object definition is sufficient to mathematically extrapolate a floor cross section for any given height of the building object. That is, if the building object extends for multiple floors, relatively simple mathematics can be used to calculate the boundary of the floor for a given height.

The simplified building object model minimises the data requirements while achieving one intended objective, which is to be able to represent additional data pertaining to a floor plan for any occupiable floor of the building. Because the objective is to represent any occupiable floor of the building, accurately depicting architectural or decorative features such as roof lines, spires, etc is not essential.

In one embodiment, a 3-D building landscape may be presented as an aid to a property listings application. In this example, a building data file may be associated with property listings data for the building that may, for example, describe areas of the building that are for lease, rent or sale. Property listing data may include, without limitation, price, area, price per area, address, floor address, layout, furnishings, agent details, owner details, current building tenants, etc.

The rendering software may be programmed to distinguish areas of a building which have a property listing from areas of a building that do not have a property listing. For example, a property listing for a floor of a building may be highlighted or differently coloured to indicate a property listing is available for that floor. In one embodiment, a floor may be presented on the building landscape as a selectable hyperlink that, when selected, displays additional property listing information as an overlay on the building landscape, in a sidebar window, or in an additional browser window.

In one embodiment, property listings may be visually depicted by reference to a property listing database, such as the database 84, to determine whether there are any property listings to display for that building. When a property listing is to be displayed, additional property listing objects that match the available floors can be created and rendered. The property listing objects may have different colouring or shading attributes that distinguish the property listing objects from other building objects of the building file.

Property listing data may be added to a building file when a property listing is added to the property listings database. For example, an agent may post a property listing specifying floors 5-8 of a 10-floor building are available for rent. This data may be added to a building file when the property listings database is updated or amended. Alternatively, the property listing data may be referenced when the building is being rendered to the client. In either case, a property listing object may be programmatically generated, i.e. automatically, from the property listing data. For the property listing example above, the rendering software may calculate all building objects that extend through floors 5 to 8 and create property listing objects matching the defined polygons for those building objects but only for floors 5 to 8. If the building object is defined only by a floor polygon, the corresponding property listing object will have the same floor polygon boundary but the height parameters will be set by the property listing data. If the building object has both a floor and roof polygon defined, the application software will calculate the boundary of a floor and roof polygon for the property listing object, for example by interpolating the respective data points for the floor (e.g. A1) and roof polygons (e.g. A2) to an intermediate point at the property listing floor height (e.g. A3).

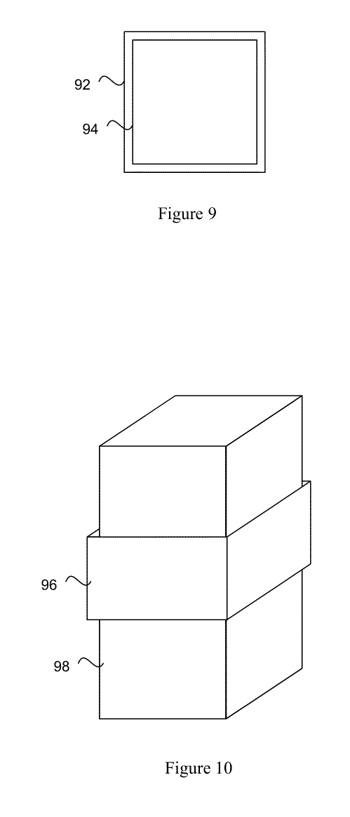

Because a property listing object will, by necessity, correspond with a building object, there may be conflicts in displaying both the property listing object and the building object on the 3-D building landscape. This may cause some property listing objects to not be visible while other property listing objects may appear to flicker, depending on view angle, zoom, etc. As shown in FIGS. 9 and 10, to resolve the conflict, in one embodiment each property listing polygon 92 may be extended outward by one or more data pixels in each direction relative to the corresponding building object polygon 94. This makes the property listing polygon external to the building object polygon such that when the two objects are overlaid, the surface of the property listing object 96 will be displayed and the surfaces of the building object polygon 98 will be hidden.

In one embodiment, where a property listing for a building is present, the entire floor may be highlighted so that the availability is visible from any viewing angle in the 3-D building landscape. In an alternative embodiment, the property listing may include floor plan data that shows only the sections of the floor that are available. Floor plan data may be defined by an agent or administrator using a similar interface to the interface illustrated in FIG. 6. Floor plan data may be uploaded from other information sources. When the a property listing having floor plan data is rendered on the 3-D landscape, only the outer surfaces of the floor plan will be visible. This facility allows a user to readily determine what views will be available from the property listing.

It can be seen from the above that the methodology described herein can reduce the size of a data file that would otherwise be required to describe a building. By dividing a building into objects that have consistent cross sections, the requirement for complete three dimensional data points for all points of a building can be reduced. However, it is not essential that each building in the database be described or defined by the methodology of the present invention. The Applicant acknowledges that many buildings or structures have complex shapes that have no consistent cross section. Buildings such as the Sydney Opera House in Sydney, Australia or the Statue of Liberty in New York, USA would be difficult to describe by the present methodology yet would remain important buildings to represent in their respective city landscapes. Thus, a database for a city landscape may include buildings described using the presently described methodology as well as buildings described through other methodologies. Buildings that do not suit the present model can still be represented on the building landscape using alternative models such as SketchUp referred to above. However, the overall data required to represent the building landscape can be significantly reduced by using the Applicant's methodology described herein wherever possible.

Furthermore, it is not essential that each object within a particular building has a consistent cross section. Many buildings might have several identifiable objects that have a consistent cross section as well as intricate decorative or architectural features that are difficult to define using the presently described methodology. For example, a building may have inhabitable lower floors of consistent cross section topped by decorative domes, towers, etc. Thus, a building data file for a single building may have a plurality of objects defined by the present methodology in addition to objects defined using other methodologies. By using the present methodology where possible to describe suitable objects, the overall size of a building data file may be reduced.

Although embodiments of the present invention have been illustrated in the accompanied drawings and described in the foregoing description, it will be understood that the invention is not limited to the embodiments disclosed, but is capable of numerous rearrangements, modifications, and substitutions without departing from the spirit of the invention as set forth herein. For example, the capabilities of the invention can be performed fully and/or partially by one or more of the blocks, modules, processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient. Also, the information sent between various modules can be sent between the modules via at least one of a data network, the Internet, an Internet Protocol network, a wireless source, and a wired source and via plurality of protocols.

What is claimed is:

1. A method for presenting a three dimensional building landscape on a graphical user interface, the method including:
(A) determining an x,y coordinate space of a viewport of the graphical user interface;
(B) searching a database of building data files to determine one or more building data files that have x,y coordinates within the x,y coordinate space; and
(C) rendering the determined building data files as three dimensional images on the graphical user interface;
(D) wherein the building data files include one or more buildings described by a plurality of building objects, the building objects including a horizontal cross section defined by a series of x,y data points and a height of the respective building object.

2. The method of claim 1 wherein rendering at least one of the building data files includes rendering one or more of the plurality of building objects of the respective building data file by projecting the horizontal cross section from a base height of the respective building object to a roof height of the respective building object.

3. The method of claim 2 wherein at least one building object includes a floor cross section defined by a first series of x,y data points and a roof cross section defined by a second series of x,y data points, the first series and the second series having the same number of x,y data points, the method including rendering the at least one building object by defining a plurality of surfaces between the floor cross section and the roof cross section, wherein defining the plurality of surfaces includes mapping, in order, the first series of x,y data points to the second series of x,y data points.

4. The method of claim 1 including referencing property listing data for at least one of the determined building files and displaying available property listing on the three dimensional image of the respective building.

5. The method of claim 4 including determining a floor height of the available property listing and displaying at least a portion of the floor height as having an available property.

6. The method of claim 4 wherein displaying an available property listing includes creating a property listing object corresponding to the horizontal cross section of at least one building object and displaying the property listing object for the determined floor height.

7. The method claim of 6 wherein creating a property listing object includes expanding a boundary of the property listing object by at least one pixel relative to the corresponding horizontal cross section.

8. A system for presenting a three dimensional building landscape on a graphical user interface, the system including:
(A) at least one database of building data files including at least one building described by a plurality of building objects, the building objects including a horizontal cross section defined by a series of x,y data points and a height of the respective building object;
(B) at least one processor operatively associated with the at least one database, the at least one processor programmed to:
(a) determine that the at least one building is to be displayed on the three dimensional building landscape;
(b) create a building object by projecting the horizontal cross section of at least one of the plurality of building objects from a base height of the respective building object to a roof height of the respective building object;
(c) display the created building object as a three dimensional image on three dimensional building landscape of the graphical user interface.

9. The system of claim 8 wherein at least one building object includes a floor cross section defined by a first series of x,y data points and a roof cross section defined by a second series of x,y data points, the first series and the second series having the same number of x,y data points, wherein the processor is programmed to create at least one building object by defining a plurality of surfaces between the floor cross section and the roof cross section, wherein defining the plurality of surfaces includes mapping, in order, the first series of x,y data points to the second series of x,y data points.

10. The system of claim 8 wherein the at least one database includes property listing data for the at least one building, wherein the processor is programmed to display at least one available property listing on the three dimensional image of the building.

11. The system of claim 10 wherein the processor is programmed to determine a floor height of the available property listing and display at least a portion of the floor height as having an available property.

12. The system of claim 10 wherein the processor is programmed to create a property listing object corresponding to the horizontal cross section of at least one building object and display the property listing object for the determined floor height.

13. The system of claim 12 wherein the processor is programmed to create a property listing object including expanding a boundary of the property listing object by at least one pixel relative to the corresponding horizontal cross section.

14. A method of creating a building data file including:
(A) presenting, by a computer system including at least one processor and at least one operatively associated memory, an interface on a display associated with the computer system that enables a user to define, through the interface, a plurality of building objects that describe a building;
(B) a mapping interface that enables a user to define a boundary of a cross section of a building object on a map and to enter one or more height parameters of the building object
(C) wherein the processor is programmed to store each of the building object definitions for the building in the building data file.

15. A method for defining a three dimensional model of a building including:
(A) dividing a building into a plurality of objects, one or more of the objects having a substantially consistent horizontal cross section through a height of the respective object;
(B) defining each of the one or more objects as a series of data points on a graphical user interface including defining the coordinates that define a boundary of an object's cross section and defining one or more data points that describe the height of the object; and
(C) storing a definition of each object in a building data file.

16. The method of claim 15 including, for at least one other of the plurality of objects other than the one or more objects having a substantially consistent horizontal cross section, defining a floor cross section by a first series of x,y data points and defining a roof cross section by a second series of x,y data points, the first series and the second series having the same number of x,y data points.
